(19) United States
(12) Patent Application Publication
(10) Pub. No.: US 2003/0091382 A1
(43) Pub. Date: May 15, 2003

(54) Non-restricting knee joint

(76) Inventors: Julie Kowalsky, Fort Myers, FL (US); Brian Mason, Simsbury, CT (US); William H. Shields, Buffalo, NY (US); Aaron R. Goss, Dallas, TX (US)

Correspondence Address: BROMBERG & SUNSTEIN LLP, 125 SUMMER STREET, BOSTON, MA, 02110-1618, US

(21) Appl. No.: 09/993,935

(22) Filed: Nov. 14, 2001

(51) Int. Cl. F16D 1/12; F16C 11/00

(52) U.S. Cl. 403/113

(57) ABSTRACT

A joint for use in an orthopedic brace has a bottom plate and at least one arm bar rotatably mounted on the bottom plate for allowing unlimited rotation of the joint within a range. At least one shaft is coupled to the arm bar. A top plate is slideably mounted along the shaft in opposition to the bottom plate. A lever mounted on the top plate engages the plates to limit the rotation of the joint to a preset angle. The lever further adjusts the rotation of the joint from unlimited rotation within the range to limited rotation within the range without resetting the preset angle.

### TECHNICAL FIELD AND BACKGROUND ART

The present invention relates to orthopedic braces and more particularly to a non-restrictive knee joint which may be adjusted between unlimited and limited ranges of motion.

The knee is the largest joint in the body. Due to everyday activity, the knee is susceptible to injury that can cause permanent damage. Individuals who suffer from lack of support in their leg require a knee brace to facilitate walking. The motions of normal walking include a stiffness of the leg to support the body and a bendable knee to swing the leg forward.

Adjustable knee braces allow the user to adjust the range of motion for activities such as sitting and walking. U.S. Pat. Nos. 4,337,764 to Lehrman, 5,460,599 to Davis et al., 4,791,916 to Paez, and 4,554,913 to Womack et al. disclose knee braces that allow for adjustable motion so the range of mobility can be escalated as healing occurs and the user's strength and walking ability improve. However, while the degree of mobility desired can be selected, it must be manually altered. Therefore, each time the user chooses to transfer between sitting and standing, the user must change the setting by altering stop pins and re-tightening screws. Other adjustable knee braces have an adjustable range of motion that can be changed to a fully locked position or a free range of motion by turning a dial on the knee joint. However, when changing from free range of motion to the limited range of motion, the user must reset the desired angle each time.

As described, prior art knee braces require the user to make manual adjustments to change from activities requiring free range motion to limited range motion. These adjustments increase the duration needed for the patient to change from sitting to walking. Furthermore, the patient is required to determine the limited range, increasing the chances that the limit could be set incorrectly.

### SUMMARY OF THE INVENTION

Embodiments of the present invention provide a joint for use in an orthopedic brace which can be adjusted from a free or unlimited range of motion to a limited range motion without making manual adjustments to set the limited range of motion of the joint. By eliminating the need to manually adjust the joint, the time required to switch from sitting to walking may be advantageously reduced. Furthermore, the correct limited range of motion is preset for the patient eliminating patient error.

In accordance with a first embodiment of the invention a joint for use in an orthopedic brace has a bottom plate and at least one arm bar rotatably mounted on the bottom plate for allowing unlimited rotation of the joint within a range. At least one shaft is coupled to the arm bar. A top plate is slideably mounted along the shaft in opposition to the bottom plate. A lever mounted on the top plate engages the plates to limit the rotation of the joint to a preset angle. The lever further adjusts the rotation of the joint from unlimited rotation within the range to limited rotation within the range, without resetting the preset angle.

In accordance with alternative embodiments of the invention, the plates are engaged when the lever is in locked position. A restraining plate may be provided for preventing upward movement of the top plate when the plates are engaged. The lever may include a block member for engaging the restraining plate. A spring may be coupled to the shaft to support the top plate in opposition to the bottom plate. The top and bottom plates may include a plurality of holes representing preset angles within the range. release member adjusts the rotation of the joint to limited rotation within the range by locking the engaged plates to the preset angle. Angle restrictors may be inserted in the holes to select the preset angle. The range may be between 0 and 90 degrees.

In accordance with another aspect of the invention, a method is provided for adjusting the rotation of a joint for use in an orthopedic brace, the joint having a top plate and an opposed bottom plate. The method has the steps of engaging the top plate with the bottom plate to limit the rotation of the joint to a preset angle within a range, disengaging the plates to allow unlimited rotation of the joint within the range, and re-engaging the plates to limit the rotation of the joint to the preset angle without resetting the preset angle.

### BRIEF DESCRIPTION OF THE DRAWINGS

The foregoing features of the invention will be more readily understood by reference to the following detailed description, taken with reference to the accompanying drawings, in which:

FIG. 1a is a perspective view of an embodiment of the present invention in the unlocked configuration;

FIG. 1b is a perspective view of the joint of FIG. 1a in the locked configuration; and

FIG. 2 is a perspective view of the joint of FIG. 1a with the top plate removed.

### DETAILED DESCRIPTION OF SPECIFIC EMBODIMENTS

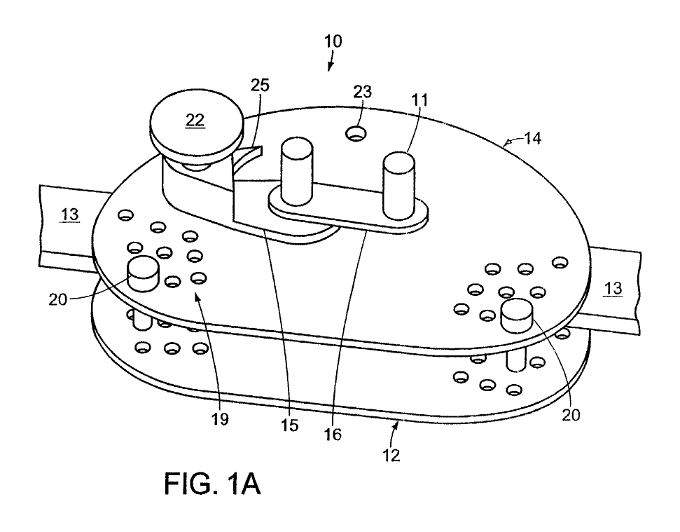

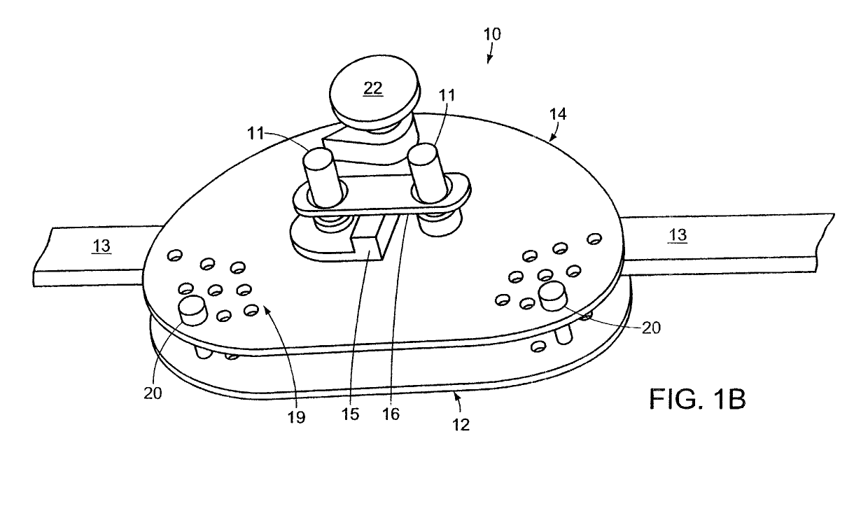

FIG. 1a is a perspective view of an embodiment of the present invention in the unlocked configuration. The prosthetic knee joint, generally designated by numeral 10 comprises a pair of shafts 11 for connecting bottom plate 12, arm bars 13, top plate 14, and a lever 15. A non-movable restraining plate 16 is fixed to the top of shafts 11 for maintaining the joint 10 in the locked configuration. Plates 12 and 14, arm bars 13, lever 15 and restraining plate 16 are provided with openings which are sized to fit shafts 11. Shafts 11, plates 12 and 14, and restraining plate 16 may be fabricated of a material, such as stainless steel, so as to make the joint 10 lightweight yet sturdy. Lever 15 may be fabricated from nylon.

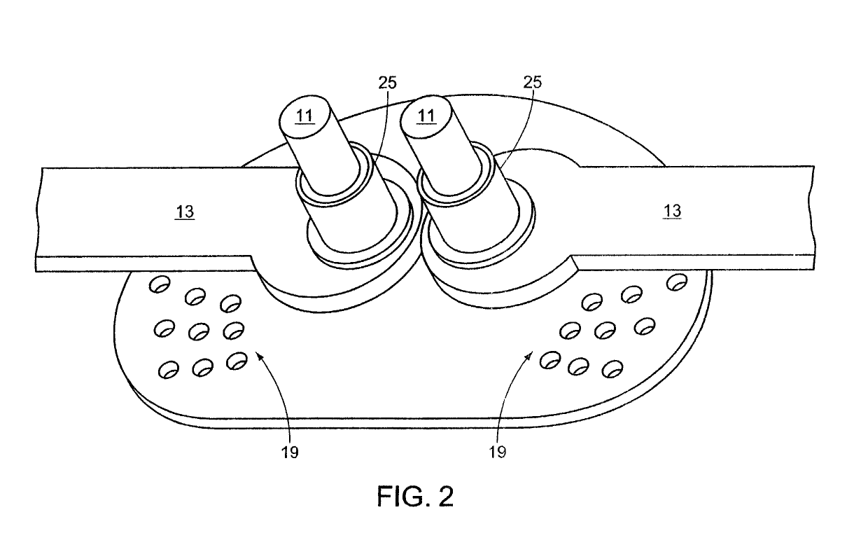

FIG. 2 is a perspective view of the joint of FIG. 1a with the top plate removed. Shafts 11 are surrounded by springs 25 for supporting the top plate 14 (as shown in FIG. 1a). Arm bars 13 are rotatable about shafts 11. Shafts 11 may be bolts which may be fixed to the bottom plate 12 using washers.

Returning to FIG. 1a, arm bars 13 serve to rotate the joint 10. When the joint 10 is in the unlocked configuration, arm bars 13 are capable of rotating the joint 10 through a range of motion. In one embodiment, the range of motion is between 0 degrees and 90 degrees, thus allowing the user of the joint to fully bend the knee for participation in nonrestrictive activities such as sitting, for example. Arm bars 13 pivot about the other and may be toothed similar to the pivoting arm bars used in the Lehrman adjustable motion brace as described in U.S. Pat. No. 4,337,764, the disclosure of which is hereby incorporated herein by reference.

Bottom plate 12 and top plate 14 each contain a plurality of corresponding holes 19 representing preset angle settings within the range of motion of the joint. In the embodiment shown in FIG. 1a, each plate has 18 holes (9 on each side of the plate). In one embodiment, the holes 19 represent angles from 10 to 90 degrees in 10-degree increments. Angle restrictors may be placed in the holes 19 in the top plate to set a preset angle for limiting the rotation of the arm bars 13 when the joint 10 is in the locked configuration. In the embodiment shown in FIG. 1a, the angle restrictors are pins 20.

Lever 15 engages the plates to lock the joint 10 and disengages the plates so as to unlock the joint 10. Lever 15 comprises a block for engaging restraining plate 16. Top plate 14 is provided with a grooved slot 25 to allow lever 15 to rotate so that the block may fit under the restraining plate 16 when the joint is in the locked configuration. Lever 15 is provided with an opening for holding lever pin 22 which fits into the grooved slot 25 in the top plate 14. Top plate 14 also contains an opening 23 for securing the lever pin 22 to prevent the block from sliding out from under the restraining plate 16 when the joint 10 is in the locked configuration.

FIG. 1b shows a perspective view of the joint of FIG. 1a in the locked configuration. In FIG. 1b, top plate 14 is pushed downward along the shafts 11 compressing the springs 25 (as shown in FIG. 2) and engaging pins 20 into corresponding holes in the bottom plate 12. The holes 19 may be threaded to aid in the insertion of the pins 20 into the plates. Lever 15 has been rotated in the grooved slot 25 (as shown in FIG. 1a) so that the block is lodged under the restraining plate 16. In this configuration the lever pin 22 secures the lever 15 to top plate 14. When the block is lodged under the restraining plate 16, the top plate 14 is prevented from moving upward. When engaged with the bottom plate, the pins 20 prevent further rotation of the arm bars 13 (as shown in FIG. 1a) past the preset angle. By removing the lever pin 22 and rotating the lever to dislodge the block from under restraining plate 16, the springs 25 on the shafts 11 (as shown in FIG. 2) uncoil pushing top plate 14 upward. When the top plate 14 is pushed upward, pins 20 are dislodged from the bottom plate, allowing the arm bars 13 to freely rotate the joint.

The pins which limit the rotation of the arm bars are of primary importance and vital to the functionality of the joint. The pins must be made of a suitable material to support the weight of individuals using the joint or the joint will not function properly and the individuals will fall. The forces exerted on the pins at the various degree increments must not exceed the failure strength of the material from which the pins are fabricated. The forces exerted on the pins may be computed from the equation Fₚᵢₙ=178181818.2 sin θ, where θ is the preset angle. In one embodiment of the invention, pins fabricated out of stainless steel having a failure strength 5.56*10ˆ 8 N/m² may be employed.

The springs must be sufficiently stiff to keep the top plate 14 lifted and the pins 20 away from the moving arm bars 13, yet loose enough to allow individuals to easily compress the top plate in order to engage the springs. In one embodiment of the invention, springs having a spring constant of 66.4 Kg/m or 44.51 lb/ft may be employed.

Having thus described various illustrative embodiments of the present invention, some of its advantages and optional features, it will be apparent that such embodiments are presented by way of example only and are not by way of limitation. Those skilled in the art could readily devise alternatives and improvements on these embodiments, as well as additional embodiments, without departing from the spirit and scope of the invention. For example, although a lever is used to lock or unlock the joint, this function may be performed by a push button. The locking/unlocking function may be hip or remote activated. The number of preset angle holes in the plates may be increased or decreased to allow the joint to be set at more or fewer angles. The increments between the preset angles may be adjusted to be more or less than 10 degrees. All such modifications are within the scope of the invention as claimed.

What is claimed is:

1. A joint for use in an orthopedic brace comprising:
a bottom plate;
at least one arm bar rotatably mounted on the bottom plate for allowing unlimited rotation of the joint within a range;
at least one shaft coupled to the bottom plate and the arm bar;
a top plate slideably mounted along the shaft in opposition to the bottom plate; and
a lever mounted on the top plate for engaging the plates to limit the rotation of the joint to a preset angle, wherein the lever allows the joint to be adjusted from unlimited rotation to limited rotation within the range without resetting the preset angle.

2. The joint of claim 1, wherein the plates are engaged when the lever is in a locked position.

3. The joint of claim 1, further comprising a restraining plate fixedly coupled to the top of the shaft for preventing upward movement of the top plate when the plates are engaged.

4. The lever of claim 3, further comprising a block member for engaging the restraining plate when the lever is in the locked position

5. The joint of claim 1, further comprising a spring coupled to the shaft for supporting top plate in opposition to the bottom plate.

6. The joint of claim 1, wherein the bottom plate further comprises a first plurality of holes and wherein each hole represents a preset angle within the range.

7. The joint of claim 6, wherein the top plate further comprises a second plurality of holes, each hole representing a preset angle within the range, wherein the second plurality of holes is aligned with the first plurality of holes in the bottom plate.

8. The joint of claim 6, wherein the first plurality of holes are threaded.

9. The joint of claim 7, wherein the second plurality of holes are threaded.

10. The joint of claim 7, further comprising at least one angle restrictor for insertion through one of the second plurality of holes in the top plate and a corresponding one of the first plurality of holes in the bottom plate to select to the preset angle.

11. The joint of claim 10, wherein the angle restrictor is a pin.

12. The joint of claim 1, wherein the range is between 0 and 90 degrees.

13. A method for adjusting the rotation of a joint for use in an orthopedic brace, the joint having a top plate and an opposed bottom plate, the method comprising:
engaging the top plate with the bottom plate to limit the rotation of the joint to a preset angle within a range;
disengaging the plates to allow unlimited rotation of the joint within the range; and
re-engaging the plates to limit the rotation of the joint to the preset angle without resetting the preset angle.

14. The method of claim 13, wherein engaging the top plate with the bottom plate to limit the rotation of the joint to a preset angle within a range further comprises:
inserting at least one angle restrictor through one of a first plurality of holes in the top plate, wherein the hole represents the preset angle;
pushing the top plate toward the bottom plate to insert the angle restrictor in a corresponding one of a second plurality of holes in the bottom plate; and
locking a lever mounted on the top place to engage the top plate with bottom plate.

15. The method of claim 13, wherein disengaging the plates to allow unlimited rotation of the joint locking the top plate to the bottom plate further comprises:
unlocking a lever mounted on the top plate to disengage the top plate from the bottom plate.

16. The method of claim 13, wherein the range is between 0 and 90 degrees.
